(19) United States
(12) Patent Application Publication
(10) Pub. No.: US 2024/0422014 A1
(43) Pub. Date: Dec. 19, 2024

(54) TEE-BASED METHOD TO ESTABLISH TRUSTED AND SECURE CHANNEL BETWEEN THE USER AND PUBLIC CLOUD ENVIRONMENT, APPARATUS, COMPUTER DEVICE, AND READABLE STORAGE MEDIUM

(71) Applicant: DBAPPSECURITY CO., LTD, Hangzhou (CN)

(72) Inventors: Wubing WANG, Hangzhou (CN); Dongde XU, Hangzhou (CN); Lifeng TAO, Hangzhou (CN); Bo LIU, Hangzhou (CN); Yuan FAN, Hangzhou (CN)

(73) Assignee: DBAPPSECURITY CO., LTD, Hangzhou (CN)

(21) Appl. No.: 18/812,970

(22) Filed: Aug. 22, 2024

Related U.S. Application Data
(63) Continuation of application No. PCT/CN2022/087886, filed on Apr. 20, 2022.

(30) Foreign Application Priority Data
Mar. 29, 2022 (CN) 202210318463.7

(51) Int. Cl. H04L 9/32; H04L 9/08

(52) U.S. Cl. CPC H04L 9/3263; H04L 9/0825; H04L 9/3247

(57) ABSTRACT

A TEE-based method to establish trusted and secure channel between the user and public cloud environment, an apparatus, a computer device, and a computer-readable storage medium are provided. After a TEE is started, a trusted measurement mechanism of the TEE is called to perform security measurement on an operation environment and an operation content of a computing node operated in the TEE, and a measurement result is sent to a trusted verification module. Relevant verification information is acquired from a remote verification server of the TEE, and the trusted verification module is controlled to verify the measurement result according to the relevant verification information. When it is confirmed that the operation environment of the computing node is credible and the operation content of the computing node is secure, a communication channel is established between the user and the computing node.

### CROSS-REFERENCE TO RELATED APPLICATION

This application is a continuation of international patent application No. PCT/CN2022/087886, filed on Apr. 20, 2022, which itself claims priority to Chinese patent application No. 202210318463.7, filed on Mar. 29, 2022, titled “COMMUNICATION METHOD AND APPARATUS, COMPUTER DEVICE, AND READABLE STORAGE MEDIUM”. The contents of the above identified applications are hereby incorporated herein in their entireties by reference.

### TECHNICAL FIELD

The present disclosure generally relates to the field of network security, and in particular, to a TEE-based method to establish trusted and secure channel between the user and public cloud environment, an apparatus, a computer device, and a computer-readable storage medium.

### BACKGROUND

A HTTPS (Hyper Text Transfer Protocol over Secure Socket Layer) provides an algorithm basis for end-to-end secure communication. However, a weakness of the HTTPS is a man-in-the-middle attack. Therefore, a CA (Certificate Authority) is introduced in the related art to verify a HTTPS server. The CA has two functions: one is to issue a certificate to a website (cloud server) to prove a legal identity of the website (cloud server), and the other one is that when the user wants to visit the website (cloud server), after obtaining the certificate from the website (cloud server), the user sends the certificate to the CA to verify whether the website (cloud server) is an authenticated legitimate website (cloud server). After the user acknowledges validity of the website (cloud server), the user may establish a secure channel with the website (cloud server) to transmit private information.

However, in a conventional threat model, the user may trust an entire website (cloud server). Therefore, the HTTPS server may be authenticated by a related CA. However, in a threat model of trusted computing, most (a network, a host, and a system) of the website (cloud server) are not trusted by the user. The user only trusts one module in the website (cloud server) that is protected by hardware, i.e., a TEE (Trusted Execution Environment). The TEE is a trusted execution environment generated by hardware and protected by hardware. Confidentiality and integrity of code and data which are operated in the environment are protected by hardware. The user usually has a requirement for privacy computing. For example, the user wants to upload data to the TEE of the website (cloud server) to perform secure computing, and ensure that the data is not acquired by the website (cloud server). Because a trusted part is located in an untrusted website (cloud server), communication between the user and the trusted part must pass through an untrusted part. The related CA cannot provide a capability of providing verification of validity of the website (cloud server) for the user. Therefore, the user cannot establish a secure channel with the cloud server. In addition, the related CA does not have a capability of detecting whether the TEE is credible and whether operation content in the TEE is secure, resulting in a problem that the user cannot establish a secure communication channel with the TEE in the related art.

### SUMMARY

According to various embodiments of the present disclosure, a TEE-based method to establish trusted and secure channel between the user and public cloud environment, an apparatus, a computer device, and a computer-readable storage medium are provided.

In a first aspect, a TEE-based method to establish trusted and secure channel between the user and public cloud environment is provided, which is configured to establish a secure communication channel between the user and a TEE in a cloud server. The method includes: after the TEE is started, calling a trusted measurement mechanism of the TEE to perform security measurement on an operation environment and an operation content of a computing node operated in the TEE, sending a measurement result to a trusted verification module, acquiring relevant verification information from a remote verification server of the TEE, controlling the trusted verification module to verify the measurement result according to the relevant verification information, so as to determine whether the operation environment of the computing node is credible and whether the operation content of the computing node is secure, and when it is confirmed that the operation environment of the computing node is credible and the operation content of the computing node is secure, establishing a communication channel between the user and the computing node. The trusted verification module is operated in a second TEE.

In some embodiments, when it is confirmed that the operation environment of the computing node is credible and the operation content of the computing node is secure, establishing the communication channel between the user and the computing node further includes: when it is confirmed that the operation environment of the computing node is credible and the operation content of the computing node is secure, controlling the trusted verification module to sign a public key of the computing node to generate a digital certificate, sending the digital certificate to the computing node, and establishing the communication channel between the user and the computing node by the digital certificate.

In some embodiments, calling the trusted measurement mechanism of the TEE to perform security measurement on the operation environment and the operation content of the computing node operated in the TEE, and sending the measurement result to the trusted verification module further includes: calling the trusted measurement mechanism of the TEE to perform security measurement on the operation environment and the operation content of the computing node operated in the TEE, generating a measurement report based on the measurement result, and sending the measurement report to the trusted verification module.

In some embodiments, controlling the trusted verification module to verify the measurement result according to the relevant verification information further includes: controlling the trusted verification module to verify the measurement report according to the relevant verification information.

In some embodiments, before calling the trusted measurement mechanism of the TEE to perform security measurement on the operation environment and the operation content of the computing node operated in the TEE, the method further includes: receiving a connection request for the TEE from the user, and creating or starting the TEE.

In some embodiments, the connection request includes at least one of private data uploading, private calculation algorithm uploading, private machine-learning model uploading, protected operation request of private calculation task, or private data downloading.

In some embodiments, the method further includes: when it is confirmed that the operation environment of the computing node is not credible or the operation content of the computing node is not secure, returning a result of connection insecurity to the user.

In a second aspect, a TEE-based apparatus to establish trusted and secure channel between the user and public cloud environment is further provided, which is configured to establish a secure communication channel between the user and a TEE in a cloud server. The apparatus includes: means for calling a trusted measurement mechanism of the TEE to perform security measurement on an operation environment and an operation content of a computing node operated in the TEE after the TEE is started, and sending a measurement result to a trusted verification module, means for acquiring relevant verification information from a remote verification server of the TEE, and controlling the trusted verification module to verify the measurement result according to the relevant verification information, so as to determine whether the operation environment of the computing node is credible and whether the operation content of the computing node is secure, and means for establishing a communication channel between the user and the computing node when it is confirmed that the operation environment of the computing node is credible and the operation content of the computing node is secure. The trusted verification module is operated in a second TEE.

In a third aspect, a computer device is further provided, including a memory, a processor, and a computer program stored on the memory and capable of running on the processor. The processor is configured to execute the computer program to implement steps of the method in the first aspect.

In a fourth aspect, a computer-readable storage medium is further provided. The computer-readable storage medium stores a computer program. The computer program is executed by a processor to implement steps of the method in the first aspect.

Details of one or more embodiments of the present disclosure are provided in the following accompanying drawings and descriptions. Other features, objectives, and advantages of the present disclosure will become apparent from the specification, the accompanying drawings, and the claims.

### BRIEF DESCRIPTION OF THE DRAWINGS

In order to more clearly illustrate the technical solutions in the embodiments of the present disclosure or the related technology, the accompanying drawings to be used in the description of the embodiments or the related technology will be briefly introduced below, and it will be obvious that the accompanying drawings in the following description are only some of the embodiments of the present disclosure, and that, for one skilled in the art, other accompanying drawings can be obtained based on these accompanying drawings without putting in creative labor.

FIG. 1 is an application scenario diagram of a TEE-based method to establish trusted and secure channel between the user and public cloud environment in one or more embodiments.

FIG. 2 is a flowchart of a TEE-based method to establish trusted and secure channel between the user and public cloud environment in one or more embodiments.

FIG. 3 is a schematic diagram of a TEE-based apparatus to establish trusted and secure channel between the user and public cloud environment in one or more embodiments.

FIG. 4 is a structural diagram of a computer device in one or more embodiments.

### DETAILED DESCRIPTION OF THE EMBODIMENT

To make objectives, technical solutions, and advantages of the present disclosure clearer, the present disclosure is described and explained with reference to the accompanying drawings and embodiments. It should be understood that the specific embodiments described herein are merely used to explain the present disclosure, and are not intended to limit the present disclosure. Based on the embodiments in the present disclosure, all other embodiments obtained by one skilled in the art without making creative labor fall within the scope of protection of the present disclosure.

It is obvious that the accompanying drawings in the following description are merely some examples or embodiments of the present disclosure. One skilled in the art may still apply the present disclosure to other similar scenarios according to the accompanying drawings without creative efforts. In addition, it is also understood that although the efforts made in a development process may be complex and lengthy, some changes in design, manufacture, or production based on technical contents disclosed in the present disclosure are just conventional technical means for one skilled in the art related to the contents disclosed in the present disclosure, and should not be construed as inadequate disclosure of the contents disclosed in the present disclosure.

The reference to “embodiment” in the present disclosure means that a particular feature, structure, or characteristic described in connection with an embodiment may be included in at least one embodiment of the present disclosure. The presence of the phrase at various points in the description does not necessarily refer to the same embodiment or to a separate or alternative embodiment that is mutually exclusive of other embodiments. It is understood by one skilled in the art, both explicitly and implicitly, that the embodiments described in the present disclosure may be combined with other embodiments without conflict.

Unless defined otherwise, technical terms or scientific terms involved in the present disclosure have the same meanings as would generally understood by one skilled in the technical field of the present disclosure. In the present disclosure, “a”, “an”, “one”, “the”, and other similar words do not indicate a quantitative limitation, which may be singular or plural. The terms such as “comprise”, “include”, “have”, and any variants thereof involved in the present disclosure are intended to cover a non-exclusive inclusion. For example, processes, methods, systems, products, or devices including a series of steps or modules (units) are not limited to these steps or modules (units) listed, and may include other steps or modules (units) not listed, or may include other steps or modules (units) inherent to these processes, methods, systems, products, or devices. Words such as “join”, “connect”, “couple”, and the like involved in the present disclosure are not limited to physical or mechanical connections, and may include electrical connections, whether direct or indirect. “A plurality of” involved in the present disclosure means two or more. The term “and/or” describes an association relationship between associated objects and represents that three relationships may exist. For example, A and/or B may represent the following three cases: only A exists, both A and B exist, and only B exists. The terms “first”, “second”, “third”, and the like involved in the present disclosure are only intended to distinguish similar objects and do not represent specific ordering of the objects.

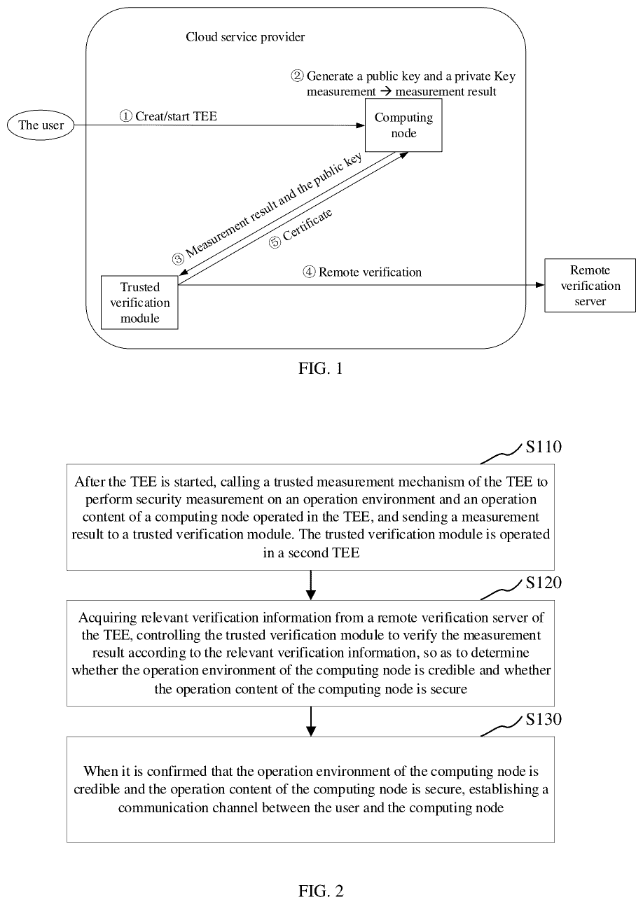

FIG. 1 is an application scenario diagram of a TEE-based method to establish trusted and secure channel between the user and public cloud environment in an embodiment of the present disclosure. Referring to FIG. 1, a cloud service provider may receive a connection request from the user by a network channel between the user and the cloud service provider (a cloud server), and create or start a TEE. After the TEE is started, the TEE calls a trusted measurement mechanism of the TEE to perform security measurement on an operation environment and an operation content of a computing node operated in the TEE, and sends a measurement result to a trusted verification module. The trusted verification module is operated in a second TEE. The trusted verification module acquires relevant verification information from a remote verification server (a trusted root server of the TEE), and verifies the measurement result according to the relevant verification information, so as to determine whether the operation environment of the computing node is credible and whether the operation content of the computing node is secure. When it is confirmed that the operation environment of the computing node is credible and the operation content of the computing node is secure, the trusted verification module signs a public key of the computing node to generate a digital certificate, and sends the digital certificate to the computing node. A communication channel is established between the user and the computing node by the digital certificate.

A TEE-based method to establish trusted and secure channel between the user and public cloud environment is provided in the present disclosure, which is configured to establish a secure communication channel between the user and a TEE in a cloud server. Referring to FIG. 2, the method includes step 110 to step 130.

Step 110 includes that after the TEE is started, calling a trusted measurement mechanism of the TEE to perform security measurement on an operation environment and an operation content of a computing node operated in the TEE, and sending a measurement result to a trusted verification module. The trusted verification module is operated in a second TEE.

Specifically, the TEE is a trusted execution environment generated by hardware and protected by hardware. Confidentiality and integrity of code and data which are operated in the environment are protected by hardware. Although the TEE is a trusted execution environment, it is possible that a cloud service provider may destroy the TEE and maliciously construct a computing node of the TEE. Therefore, after the TEE is started, the operation environment and the operation content of the computing node operated in the TEE need to be detected, so as to ensure that the operation environment of the computing node is credible (a real TEE is not damaged by the cloud service provider) and the operation content of the computing node is secure (not maliciously constructed by the cloud service provider). In this way, a communication channel may be established between the user and the computing node, so as to ensure that the communication channel between the user and the TEE in the cloud server is secure. In the present embodiment, the trusted verification module has been verified as trusted, and the trusted verification module is operated in a second TEE. The second TEE has also been verified to ensure a real TEE. Therefore, trusted startup of the real TEE may ensure that the started trusted verification module is credible. When the cloud service provider modifies a source code of a program of the trusted verification module, the modification may be detected by the trusted startup of the TEE, and the startup of the TEE may be rejected. In addition, security of the trusted verification module in an operation process may be ensured by a mechanism of the TEE itself. For example, the TEE may protect memory in the TEE, restrict access of the cloud service provider to the memory of the TEE, ensuring that the cloud service provider cannot destroy memory integrity of the trusted verification module in the operation process of the trusted verification module, and therefore cannot maliciously insert a certificate of the cloud service provider into the trusted verification module. In this way, the startup and the operation of the trusted verification module may be fully protected. The trusted verification module may include a trusted verification processor and the like.

In addition, the trusted measurement mechanism of the TEE may be a measurement mechanism of the TEE, the trusted measurement mechanism of the TEE may be called to perform security measurement on a signature of the operation environment of the computing node (when the TEE is started, a signature is signed), to obtain a measurement result, perform security measurement on the operation content of the computing node, to obtain a measurement value (such as, a hash value), and send the measurement result to the trusted verification module for verification. The trusted verification module verifies the measurement result. In an attack manner, the cloud service provider may perform a replay attack on the measurement result after intercepting a valid measurement result. However, due to a NONCE field and an integrity protection field denoted as MAC in the measurement result obtained by calling the trusted measurement mechanism of the TEE, the trusted verification module may effectively identify the replay attack of the cloud service provider according to the NONCE field and the integrity protection field MAC when verifying the measurement result.

Step 120 includes that acquiring relevant verification information from a remote verification server of the TEE, controlling the trusted verification module to verify the measurement result according to the relevant verification information, so as to determine whether the operation environment of the computing node is credible and whether the operation content of the computing node is secure.

Specifically, the remote verification server may be a trusted root server of the TEE, the relevant verification information is acquired from the remote verification server of the TEE, and the trusted verification module is controlled to verify the measurement result according to the relevant verification information. The measurement result is verified by a related remote verification, so as to determine whether the operation environment of the computing node is a real TEE and whether the operation content of the computing node is secure. In an embodiment, the TEE may have a TPM (Trusted Platform Module) that is configured to store a measurement value of a security program. The measurement value of the operation content of the computing node and the measurement value of the security program may be compared and verified, so as to determine whether the operation content of the computing node is secure.

Step 130 includes that when it is confirmed that the operation environment of the computing node is credible and the operation content of the computing node is secure, establishing a communication channel between the user and the computing node.

Specifically, when it is confirmed that the operation environment of the computing node is credible and the operation content of the computing node is secure, a secure channel may be established between the user and the computing node in a manner similar to establishing a HTTPS channel, and the user may upload data to the TEE for secure computing.

In the related art, a CA is introduced to verify a HTTPS server. However, the related CA cannot provide a capability of providing verification of validity of the website (cloud server) for the user. Therefore, the user cannot establish a secure channel with the cloud server. In addition, the related CA does not have a capability of detecting whether the TEE is credible and whether operation content in the TEE is secure, resulting in a problem that the user cannot establish a secure communication channel with the TEE in the related art.

To solve the above problem, the TEE-based method to establish trusted and secure channel between the user and public cloud environment is provided in the present disclosure. After the TEE is started, the trusted measurement mechanism of the TEE is called to perform security measurement on the operation environment and the operation content of the computing node operated in the TEE, the measurement result is sent to the trusted verification module, and the trusted verification module is operated in a second TEE. The relevant verification information is acquired from the remote verification server of the TEE, the trusted verification module is controlled to verify the measurement result according to the relevant verification information, so as to determine whether the operation environment of the computing node is credible and whether the operation content of the computing node is secure. When it is confirmed that the operation environment of the computing node is credible and the operation content of the computing node is secure, the communication channel is established between the user and the computing node. In the present disclosure, the trusted verification module is operated in the second TEE, effectively avoiding malicious tampering by the cloud server with the trusted verification module. The trusted measurement mechanism of the TEE is called to perform security measurement on the operation environment and the operation content of the computing node operated in the TEE, and the trusted verification module verifies the measurement result. When it is confirmed that the operation environment of the computing node is credible and the operation content of the computing node is secure, the communication channel between the user and the TEE in the cloud server is established. A security function provided by the TEE, an attack defense field in the trusted measurement mechanism of the TEE, and a verification function of the trusted verification module may be fully used, so as to effectively avoid malicious attacks by the cloud server or other websites, and establish a security communication channel between the user and the TEE in the cloud server.

In an embodiment, the step 130 may further include step 131 and step 132.

Step 131 may include that when it is confirmed that the operation environment of the computing node is credible and the operation content of the computing node is secure, controlling the trusted verification module to sign a public key of the computing node to generate a digital certificate, and sending the digital certificate to the computing node.

Step 132 may include that establishing the communication channel between the user and the computing node by the digital certificate.

Specifically, because the trusted verification module is credible, when it is confirmed that the operation environment of the computing node is credible and the operation content of the computing node is secure, the trusted verification module may be controlled to sign the public key of the computing node to generate the digital certificate, which is equivalent to providing a trusted certificate for the computing node. In addition, the communication channel may be established between the user and the computing node by the digital certificate, thereby ensuring privacy and security of communication between the user and the computing node. In an attack manner, the cloud service provider may create a malicious public key and pass the malicious public key into the trusted verification module through a normal interface of the trusted verification module to obtain the digital certificate signed by the trusted verification module. However, the cloud service provider does not have the measurement result of the TEE, so the malicious public key may be rejected by the trusted verification module, thereby effectively avoiding malicious attacks of the cloud service provider.

In an embodiment, the step 110 may further include step 111 and step 112.

Step 111 may include that calling the trusted measurement mechanism of the TEE to perform security measurement on the operation environment and the operation content of the computing node operated in the TEE, and generating a measurement report based on the measurement result.

Step 112 may include that sending the measurement report to the trusted verification module.

Specifically, the measurement report may be generated based on the measurement result, the measurement report may extract effective information of the measurement result and display the measurement result in a certain format, so that the measurement result may be summarized and displayed more clearly.

In an embodiment, the step 120 may further include step 121.

Step 121 may include that controlling the trusted verification module to verify the measurement report according to the relevant verification information.

Because the measurement result displayed in the measurement report is clearer, the trusted verification module may be controlled to verify the measurement report according to the relevant verification information, thereby effectively improving verification efficiency of the trusted verification module.

In an embodiment, at the step 110, before calling the trusted measurement mechanism of the TEE to perform security measurement on the operation environment and the operation content of the computing node operated in the TEE, the method may further include step 100.

Step 100 may include that receiving a connection request for the TEE from the user, and creating or starting the TEE.

Specifically, when the connection request for the TEE from the user is received, it is possible that no computing node is started in the cloud service provider. Therefore, when the connection request for the TEE from the user is received, the TEE needs to be created or started to ensure a response to the request of the user.

In an embodiment, the connection request may include at least one of private data uploading, private calculation algorithm uploading, private machine-learning model uploading, protected operation request of private calculation task, or private data downloading.

In an embodiment, the method may further include: when it is confirmed that the operation environment of the computing node is not credible or the operation content of the computing node is not secure, returning a result of connection insecurity to the user.

Specifically, when it is confirmed that the operation environment of the computing node is not credible or the operation content of the computing node is not secure, a result of connection insecurity may be returned to the user, so that a current connection status may be effectively notified to the user, thereby avoiding the user waiting continuously.

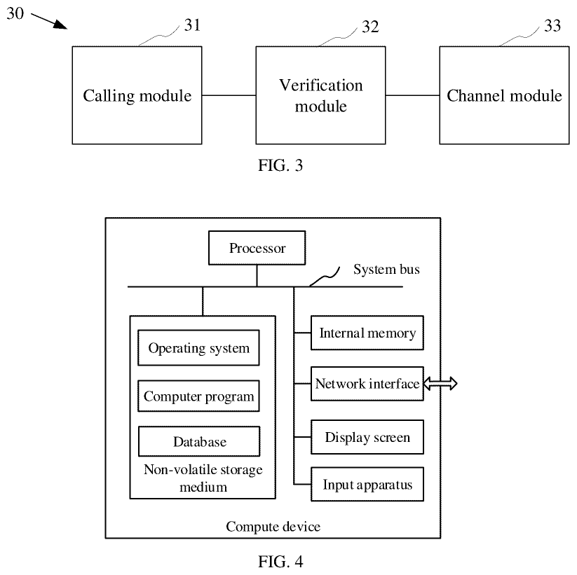

FIG. 3 is a schematic diagram of a TEE-based apparatus to establish trusted and secure channel between the user and public cloud environment in one or more embodiments. Referring to FIG. 3, a TEE-based apparatus 30 to establish trusted and secure channel between the user and public cloud environment is provided, including a calling module 31, a verification module 32, and a channel module 33.

The calling module 31 is configured for calling a trusted measurement mechanism of the TEE to perform security measurement on an operation environment and an operation content of a computing node operated in the TEE after the TEE is started, and sending a measurement result to a trusted verification module. The trusted verification module is operated in a second TEE.

The verification module 32 is configured for acquiring relevant verification information from a remote verification server of the TEE, and controlling the trusted verification module to verify the measurement result according to the relevant verification information, so as to determine whether the operation environment of the computing node is credible and whether the operation content of the computing node is secure.

The channel module 33 is configured for establishing a communication channel between the user and the computing node when it is confirmed that the operation environment of the computing node is credible and the operation content of the computing node is secure.

In the above apparatus 30, after the TEE is started, the trusted measurement mechanism of the TEE is called to perform security measurement on the operation environment and the operation content of the computing node operated in the TEE, the measurement result is sent to the trusted verification module, and the trusted verification module is operated in a second TEE. The relevant verification information is acquired from the remote verification server of the TEE, the trusted verification module is controlled to verify the measurement result according to the relevant verification information, so as to determine whether the operation environment of the computing node is credible and whether the operation content of the computing node is secure. When it is confirmed that the operation environment of the computing node is credible and the operation content of the computing node is secure, the communication channel is established between the user and the computing node. In the present disclosure, the trusted verification module is operated in the second TEE, effectively avoiding malicious tampering by the cloud server with the trusted verification module. The trusted measurement mechanism of the TEE is called to perform security measurement on the operation environment and the operation content of the computing node operated in the TEE, and the trusted verification module verifies the measurement result. When it is confirmed that the operation environment of the computing node is credible and the operation content of the computing node is secure, the communication channel between the user and the TEE in the cloud server is established. A security function provided by the TEE, an attack defense field in the trusted measurement mechanism of the TEE, and a verification function of the trusted verification module may be fully used, so as to effectively avoid malicious attacks by the cloud server or other websites, and establish a security communication channel between the user and the TEE in the cloud server.

In an embodiment, the channel module 33 is further configured for controlling the trusted verification module to sign a public key of the computing node to generate a digital certificate when it is confirmed that the operation environment of the computing node is credible and the operation content of the computing node is secure, sending the digital certificate to the computing node, and establishing the communication channel between the user and the computing node by the digital certificate.

In an embodiment, the calling module 31 is further configured for calling the trusted measurement mechanism of the TEE to perform security measurement on the operation environment and the operation content of the computing node operated in the TEE, generating a measurement report based on the measurement result, and sending the measurement report to the trusted verification module.

In an embodiment, the verification module 32 is further configured for controlling the trusted verification module to verify the measurement report according to the relevant verification information.

In an embodiment, the apparatus 30 may further include a startup module, which is configured for receiving a connection request for the TEE from the user before calling the trusted measurement mechanism of the TEE to perform security measurement on the operation environment and the operation content of the computing node operated in the TEE, and creating or starting the TEE.

In an embodiment, the connection request may include at least one of private data uploading, private calculation algorithm uploading, private machine-learning model uploading, protected operation request of private calculation task, or private data downloading.

In an embodiment, the apparatus 30 may further include a notification module, which is configured for returning a result of connection insecurity to the user when it is confirmed that the operation environment of the computing node is not credible or the operation content of the computing node is not secure.

It should be noted that any above module may be a function module or a program module, and be implemented in whole or in part by software, hardware, and a combination thereof. The foregoing module may be embedded in or independent of a processor in a computer device in a hardware form, or may be stored in a memory in the computer device in a software form, so that the processor may call and execute an operation corresponding to the foregoing module.

In an embodiment, a computer device is provided. The computer device may be a server, and an internal structure diagram of the computer device may be shown in FIG. 4. The computer device includes a processor, a memory, and a network interface. The processor of the computer device is configured to provide a computing and control capability. The memory of the computer device includes a non-volatile storage medium and an internal memory. The non-volatile storage medium stores an operating system, a computer program, and a database. The internal memory provides an environment for operation of the operating system and the computer program in the non-volatile storage medium. The database of the computer device is configured to store an information set of preset configurations. The network interface of the computer device is configured to be in communication with an external terminal by network connection. The computer program is executed by the processor to implement the above method.

In an embodiment, a computer device is provided. The computer device may be a terminal. The computer device includes a processor, a memory, a network interface, a display screen, and an input apparatus that are connected by a system bus. The processor of the computer device is configured to provide a computing and control capability. The memory of the computer device includes a non-volatile storage medium and an internal memory. The non-volatile storage medium stores an operating system, a computer program, and a database. The internal memory provides an environment for operation of the operating system and the computer program in a non-volatile storage medium. The network interface of the computer device is configured to be in communication with an external terminal by network connection. The computer program is executed by the processor to implement the above method. The display screen of the computer device may be a liquid crystal display screen or an electronic ink display screen. The input apparatus of the computer device may be a touch layer covered on the display screen, may be a key, a trackball, or a touchpad disposed on a housing of the computer device, or may be an external keyboard, a touchpad, or a mouse.

One skilled in the art may understand that the structure shown in FIG. 4 is merely a block diagram of some structures related to the solutions of the present disclosure, and does not constitute a limitation on a computer device to which the solutions of the present disclosure are applied. A specific computer device may include more or fewer components than those shown in the figure, or combine some components, or have different component arrangements.

In an embodiment, a computer-readable storage medium is provided, and a computer program is stored thereon. When being executed by a processor, the computer program implements following steps: after the TEE is started, calling a trusted measurement mechanism of the TEE to perform security measurement on an operation environment and an operation content of a computing node operated in the TEE, sending a measurement result to a trusted verification module, acquiring relevant verification information from a remote verification server of the TEE, controlling the trusted verification module to verify the measurement result according to the relevant verification information, so as to determine whether the operation environment of the computing node is credible and whether the operation content of the computing node is secure, and when it is confirmed that the operation environment of the computing node is credible and the operation content of the computing node is secure, establishing a communication channel between the user and the computing node. The trusted verification module is operated in a second TEE.

In an embodiment, when executing the computer program, the processor further implements following steps: when it is confirmed that the operation environment of the computing node is credible and the operation content of the computing node is secure, controlling the trusted verification module to sign a public key of the computing node to generate a digital certificate, sending the digital certificate to the computing node, and establishing the communication channel between the user and the computing node by the digital certificate.

In an embodiment, when executing the computer program, the processor further implements following steps: calling the trusted measurement mechanism of the TEE to perform security measurement on the operation environment and the operation content of the computing node operated in the TEE, generating a measurement report based on the measurement result, and sending the measurement report to the trusted verification module.

In an embodiment, when executing the computer program, the processor further implements following steps: controlling the trusted verification module to verify the measurement report according to the relevant verification information.

In an embodiment, before calling the trusted measurement mechanism of the TEE to perform security measurement on the operation environment and the operation content of the computing node operated in the TEE, the processor further implements following steps when executing the computer program: receiving a connection request for the TEE from the user, and creating or starting the TEE.

In an embodiment, the connection request may include at least one of private data uploading, private calculation algorithm uploading, private machine-learning model uploading, protected operation request of private calculation task, or private data downloading.

In an embodiment, when executing the computer program, the processor further implements following steps: when it is confirmed that the operation environment of the computing node is not credible or the operation content of the computing node is not secure, returning a result of connection insecurity to the user.

In the computer-readable storage medium, after the TEE is started, the trusted measurement mechanism of the TEE is called to perform security measurement on the operation environment and the operation content of the computing node operated in the TEE, the measurement result is sent to the trusted verification module, and the trusted verification module is operated in a second TEE. The relevant verification information is acquired from the remote verification server of the TEE, the trusted verification module is controlled to verify the measurement result according to the relevant verification information, so as to determine whether the operation environment of the computing node is credible and whether the operation content of the computing node is secure. When it is confirmed that the operation environment of the computing node is credible and the operation content of the computing node is secure, the communication channel is established between the user and the computing node. In the present disclosure, the trusted verification module is operated in the second TEE, effectively avoiding malicious tampering by the cloud server with the trusted verification module. The trusted measurement mechanism of the TEE is called to perform security measurement on the operation environment and the operation content of the computing node operated in the TEE, and the trusted verification module verifies the measurement result. When it is confirmed that the operation environment of the computing node is credible and the operation content of the computing node is secure, the communication channel between the user and the TEE in the cloud server is established. A security function provided by the TEE, an attack defense field in the trusted measurement mechanism of the TEE, and a verification function of the trusted verification module may be fully used, so as to effectively avoid malicious attacks by the cloud server or other websites, and establish a security communication channel between the user and the TEE in the cloud server.

The various technical features of the above-described embodiments may be combined arbitrarily, and all possible combinations of the various technical features of the above-described embodiments have not been described for the sake of conciseness of description. However, as long as there is no contradiction in the combinations of these technical features, they should be considered to be within the scope of the present specification.

The above-described embodiments express only several embodiments of the present disclosure, which are described in a more specific and detailed manner, but are not to be construed as a limitation on the scope of the present disclosure. For one skilled in the art, several deformations and improvements can be made without departing from the conception of the present disclosure, all of which fall within the scope of protection of the present disclosure. Therefore, the scope of protection of the present disclosure shall be subject to the attached claims.

What is claimed is:

1. A TEE-based method to establish trusted and secure channel between the user and public cloud environment, configured to establish a secure communication channel between the user and a TEE (Trusted Execution Environment) in a cloud server, comprising:
after the TEE is started, calling a trusted measurement mechanism of the TEE to perform security measurement on an operation environment and an operation content of a computing node operated in the TEE, and sending a measurement result to a trusted verification module, wherein the trusted verification module is operated in a second TEE;
acquiring relevant verification information from a remote verification server of the TEE, and controlling the trusted verification module to verify the measurement result according to the relevant verification information, so as to determine whether the operation environment of the computing node is credible and whether the operation content of the computing node is secure; and
when it is confirmed that the operation environment of the computing node is credible and the operation content of the computing node is secure, establishing a communication channel between the user and the computing node.

2. The method of claim 1, wherein when it is confirmed that the operation environment of the computing node is credible and the operation content of the computing node is secure, establishing the communication channel between the user and the computing node further comprises:
when it is confirmed that the operation environment of the computing node is credible and the operation content of the computing node is secure, controlling the trusted verification module to sign a public key of the computing node to generate a digital certificate, and sending the digital certificate to the computing node; and
establishing the communication channel between the user and the computing node by the digital certificate.

3. The method of claim 1, wherein calling the trusted measurement mechanism of the TEE to perform security measurement on the operation environment and the operation content of the computing node operated in the TEE, and sending the measurement result to the trusted verification module further comprises:
calling the trusted measurement mechanism of the TEE to perform security measurement on the operation environment and the operation content of the computing node operated in the TEE, generating a measurement report based on the measurement result, and sending the measurement report to the trusted verification module.

4. The method of claim 3, wherein controlling the trusted verification module to verify the measurement result according to the relevant verification information further comprises:
controlling the trusted verification module to verify the measurement report according to the relevant verification information.

5. The method of claim 1, wherein before calling the trusted measurement mechanism of the TEE to perform security measurement on the operation environment and the operation content of the computing node operated in the TEE, the method further comprises:
receiving a connection request for the TEE from the user, and creating or starting the TEE.

6. The method of claim 5, wherein the connection request comprises at least one of private data uploading, private calculation algorithm uploading, private machine-learning model uploading, protected operation request of private calculation task, or private data downloading.

7. The method of claim 5, further comprising:
when it is confirmed that the operation environment of the computing node is not credible or the operation content of the computing node is not secure, returning a result of connection insecurity to the user.

8. A TEE-based apparatus to establish trusted and secure channel between the user and public cloud environment, configured to establish a secure communication channel between the user and a TEE in a cloud server, comprising:
means for calling a trusted measurement mechanism of the TEE to perform security measurement on an operation environment and an operation content of a computing node operated in the TEE after the TEE is started, and sending a measurement result to a trusted verification module, wherein the trusted verification module is operated in a second TEE;
means for acquiring relevant verification information from a remote verification server of the TEE, and controlling the trusted verification module to verify the measurement result according to the relevant verification information, so as to determine whether the operation environment of the computing node is credible and whether the operation content of the computing node is secure; and
means for establishing a communication channel between the user and the computing node when it is confirmed that the operation environment of the computing node is credible and the operation content of the computing node is secure.

9. A computer device, comprising a memory and a processor, wherein a computer program is stored in the memory, and the processor is configured to execute the computer program to implement steps of the method of claim 1.

10. The computer device of claim 9, wherein when it is confirmed that the operation environment of the computing node is credible and the operation content of the computing node is secure, establishing the communication channel between the user and the computing node further comprises:
when it is confirmed that the operation environment of the computing node is credible and the operation content of the computing node is secure, controlling the trusted verification module to sign a public key of the computing node to generate a digital certificate, and sending the digital certificate to the computing node; and
establishing the communication channel between the user and the computing node by the digital certificate.

11. The computer device of claim 9, wherein calling the trusted measurement mechanism of the TEE to perform security measurement on the operation environment and the operation content of the computing node operated in the TEE, and sending the measurement result to the trusted verification module further comprises:
calling the trusted measurement mechanism of the TEE to perform security measurement on the operation environment and the operation content of the computing node operated in the TEE, generating a measurement report based on the measurement result, and sending the measurement report to the trusted verification module.

12. The computer device of claim 11, wherein controlling the trusted verification module to verify the measurement result according to the relevant verification information further comprises:
controlling the trusted verification module to verify the measurement report according to the relevant verification information.

13. The computer device of claim 9, wherein before calling the trusted measurement mechanism of the TEE to perform security measurement on the operation environment and the operation content of the computing node operated in the TEE, the method further comprises:
receiving a connection request for the TEE from the user, and creating or starting the TEE.

14. The computer device of claim 13, wherein the connection request comprises at least one of private data uploading, private calculation algorithm uploading, private machine-learning model uploading, protected operation request of private calculation task, or private data downloading.

15. The computer device of claim 13, further comprising:
when it is confirmed that the operation environment of the computing node is not credible or the operation content of the computing node is not secure, returning a result of connection insecurity to the user.

16. A computer-readable storage medium, storing a computer program, wherein the computer program is executed by a processor to implement steps of the method of claim 1.

17. The computer-readable storage medium of claim 16, wherein when it is confirmed that the operation environment of the computing node is credible and the operation content of the computing node is secure, establishing the communication channel between the user and the computing node further comprises:
when it is confirmed that the operation environment of the computing node is credible and the operation content of the computing node is secure, controlling the trusted verification module to sign a public key of the computing node to generate a digital certificate, and sending the digital certificate to the computing node; and
establishing the communication channel between the user and the computing node by the digital certificate.

18. The computer-readable storage medium of claim 16, wherein calling the trusted measurement mechanism of the TEE to perform security measurement on the operation environment and the operation content of the computing node operated in the TEE, and sending the measurement result to the trusted verification module further comprises:
calling the trusted measurement mechanism of the TEE to perform security measurement on the operation environment and the operation content of the computing node operated in the TEE, generating a measurement report based on the measurement result, and sending the measurement report to the trusted verification module.

19. The computer-readable storage medium of claim 18, wherein controlling the trusted verification module to verify the measurement result according to the relevant verification information further comprises:
controlling the trusted verification module to verify the measurement report according to the relevant verification information.

20. The computer-readable storage medium of claim 16, wherein before calling the trusted measurement mechanism of the TEE to perform security measurement on the operation environment and the operation content of the computing node operated in the TEE, the method further comprises:
receiving a connection request for the TEE from the user, and creating or starting the TEE.
